(19) United States
(12) Patent Application Publication
(10) Pub. No.: US 2008/0309022 A1
(43) Pub. Date: Dec. 18, 2008

(54) Two-Part Oil Scraper Ring for Internal Combustion Engines

(76) Inventors: Michael Hummel, Stuttgart (DE); Alexandros Mizoglou, Stuttgart (DE)

Correspondence Address: COLLARD & ROE, P.C., 1077 NORTHERN BOULEVARD, ROSLYN, NY, 11576, US

(21) Appl. No.: 11/990,046

(22) PCT Filed: Jul. 18, 2006
(86) PCT No.: PCT/DE2006/001239

§ 371 Date: Jul. 25, 2008

(30) Foreign Application Priority Data
Aug. 6, 2005 (DE) 10 2005 037 205.8

(51) Int. Cl. F16J 9/20

(52) U.S. Cl. 277/481

(57) ABSTRACT

In the case of a two-part oil scraper ring (10) for internal combustion engines, having a U-shaped expanding-spring ring (1), which is provided with axial indentations (2), for forming radially outwardly aligned resilient limbs (3, 4) which are connected to one another by means of radially inwardly situated webs (5), and having an annular body (7) which is provided with in each case parallel flanks (7a, 7b) and a running face (9), according to the invention, a minimum axial installation height with an improved oil-scraping effect should be obtained in that the flanks (7a, 7b) of the annular body have, in their radially inwardly situated wall region, cut-outs (11) which have a support face (12) for the engagement of the resilient limbs (3, 4) of the expanding-spring ring and are shaped such that the nominal height of the oil scraper ring is determined exclusively by the height of the annular body (7).

The invention relates to a two-part oil wiping ring for internal combustion engines, having a U-shaped spreader spring ring provided with axial incisions, for forming resilient shanks directed radially outward, and having a ring body provided with parallel flanks, in each instance, and a running surface, which body is disposed between the resilient shanks, whereby only the ring body lies against the cylinder wall in the installed state.

A two-part oil wiping ring having an spreader spring ring configured in U shape is known from DE 197 04 754 C1. A single lamella that is disposed between the shanks of the spreader spring ring permits a construction height of the oil wiping ring of approximately 1.5 mm. As compared with other known two-part oil wiping rings, for example those known from DE 27 11 018 C2, this solution possesses the advantage that a tangential force that is still sufficient is exerted on the lamella by the spreader spring, so that the oil wiping effect can also be considered to still be sufficient. A reduction in the construction height to as low as or below 1.5 mm thereby leads to an insufficient wiping effect, as is also described in DE 197 94 754 C2, so that construction heights on this order of magnitude therefore no longer appear to be possible to implement for three-part rings.

It is the task of the present invention to indicate a two-part oil wiping ring that permits a significantly improved oil wiping effect at a further reduced axial construction height, as compared with oil wiping rings of the type stated.

According to the invention, this task is accomplished by means of the characteristics of claim 1.

By means of the proposed design of the oil wiping ring, which consists of a U-shaped spreader spring ring having a ring body disposed between its shanks, on the one hand, a construction height is achieved, in advantageous manner, that is less than that of a two-part oil wiping ring, for example the one according to DE 197 04 754 C1. On the other hand, a tangential force is exerted on the ring body by means of the spreader spring ring that is used, which force is further increased in that a specific configuration of the contact surface for the spreader spring shanks is provided, so that an additional tangential force component on the ring body is produced, which leads to an improved oil wiping effect. In addition, the configuration of the contact surface permits significantly simplified assembly of the ring body.

Advantageous further developments are the subject of the dependent claims.

The invention will be explained in greater detail in the following, using an exemplary embodiment. The figures show:

FIG. 1 a perspective view of the oil wiping ring according to the invention;

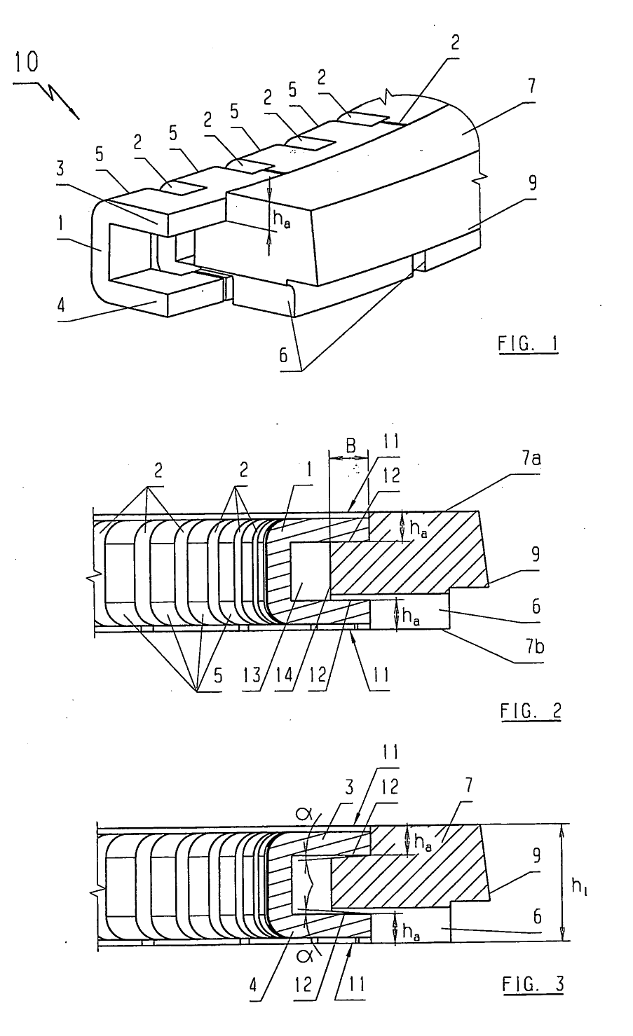

FIG. 2 a perspective sectional representation of the oil wiping ring in a first embodiment;

FIG. 3 a perspective sectional representation of the oil wiping ring in a second embodiment;

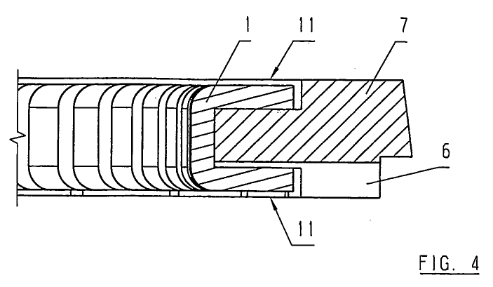

FIG. 4 a perspective sectional representation of the oil wiping ring in a third embodiment.

In the perspective view according to FIG. 1, an oil wiping ring 10 according to the invention is formed from an spreader spring ring 1 having a U-shaped cross-section, between whose shanks 3 and 4, which are radially directed outward, a ring body 7 having a running surface 9 are disposed. The spreader spring ring 1 has slits 2 on its radially inner side, so that the shanks 3 and 4 are connected with one another by way of crosspieces 5 that are configured as spring ring backs. The spreader spring ring 1 is structured to be resilient in the circumference direction, by means of the slits 2.

The ring body 7, which consists of steel or cast iron, and can be structured as a Napier ring, has flanks 7a and 7b that are oriented parallel to one another, in each instance. The flanks possess a roughness of Rz<2 μm for a steel ring body and Rz<4 μm for a cast ring body. According to FIGS. 2 and 3, the ring body 7 has a recess 11 directed axially upward, and a recess 11 directly axially downward, each having a contact surface 12, in which the shanks 3 and 4 support themselves in resilient manner, at its radially inner end, in other words in the direction of the back of the spreader spring ring 1. According to a first exemplary embodiment, the contact surface 12 is oriented parallel to the flanks 7a and 7b, whereby according to a second exemplary embodiment according to FIG. 3, the contact surface 12 runs at an incline angle α between 2° to 20° towards the stack plane. As a result, simple assembly of the ring body is made possible, on the one hand, and on the other hand, an at least partial additional force component that acts radially on the ring body is created, for a better oil wiping effect.

The recesses 12 in the ring body 7 are structured with mirror symmetry relative to one another, with the radial center axis as the mirror plane, and have a height hₐ that is greater than the thickness Dᵢ of a shank of the spreader spring ring 1, in each instance. In this way, in contrast to the existing state of the art, a nominal height of the oil wiping ring 10 is implemented that is exclusively determined by means of the height h_{L} of the ring body 7. The support of the shanks 3 and 4 of the spreader spring ring 1 takes place in a radial width B of the contact surface 12, which corresponds to approximately one-third of the radial total width of the lamellae, so that sufficient guidance is guaranteed. Oil grooves 6 that run radially are worked in on the lower flank 7a, on the circumference side, at an angle distance of 20°, in other words a total number of 18 pieces, by means of which oil to be wiped off the cylinder wall is transported to the side of the spreader spring ring that lies radially on the inside, by the ring body 7, and transported away to the engine space on the crankshaft side, by means of the incisions 2.

According to a third exemplary embodiment of the oil wiping ring 10 according to the invention, according to FIG. 4, the recesses 11 of the ring body 7 are structured in such a manner that the side 14 of the ring body that faces away from the running surface 9 lies against the back of the spreader spring ring 1, thereby making it possible to increase the radial width B of the contact surface 12. In this connection, the oil to be wiped off the cylinder wall is directly transported away to the engine space on the crankshaft side by way of the incisions 6 by means of the oil grooves 6 that run radially.

The ring body 7 can usually be treated to form a nitride layer, by means of a gas nitration process (GNS). Likewise, a friction-wear coating of the running surfaces 9 can be applied by means of a PVD method, for example a CrN coating.

The oil wiping ring 10 is inserted in the oil ring groove of a piston with sufficient play, in the installed state, whereby in the installed state, only the ring body lies against the cylinder wall. In this connection, the spreader spring ring 1 is tightened to a smaller diameter, in that it is compressed in the circumference direction, so that the radial spring force that results presses the ring body 7 against the cylinder wall, whereby an axial construction height for a two-part oil wiping ring can be implemented, by means of the special configuration of the recess 11 for accommodating the shanks 3 and 4 of the spreader spring ring 1, which height amounts to less than 1.5 mm.

### REFERENCE SYMBOLS

10 two-part oil wiping ring
1 spreader spring ring
2 axial incisions
3, 4 shanks of the spreader spring ring
5 crosspieces
6 oil groove
7 ring body
7a ring flank, axial top
7b ring flank, axial bottom
9 running surface
11 recess
12 contact surface
α a angle of incline of the contact surface
B radial width of the contact surface
Di shank thickness
h_{L} nominal height of the oil wiping ring
h_{A} axial height of the recess

1: Two-part oil wiping ring (10) for internal combustion engines, having a U-shaped spreader spring ring (1) provided with axial incisions (2), for forming resilient shanks (3, 4) directed radially outward, and having a ring body (7) provided with parallel flanks (7a, 7b), in each instance, and a running surface (9), which body is disposed between the resilient shanks of the spreader spring ring, whereby the flanks (7a, 7b) of the ring body have recesses (11) having a contact surface (12) for engagement of the resilient shanks (3, 4) of the spreader spring ring, in its wall region that lies radially on the inside, and whereby the nominal height of the oil wiping ring is exclusively determined by the height (h_{L}) of the ring body (7), wherein the contact surface (12) of the recesses (11) is structured to be inclined radially inward towards the radial center axis, in its axial height (hₐ).

2-4. (canceled)

5: Two-part oil wiping ring (10) according to claim 1, wherein the angle of incline (a) amounts to between 2° and 20°.

6: Two-part oil wiping ring (10) according to claim 1, wherein the ring body (7) has grooves (6) for the oil to run off, distributed over the circumference, over its entire radial wall thickness.

7: Two-part oil wiping ring (10) according to claim 6, wherein the grooves (6) are made in the ring body flank (7b) that is disposed axially at the bottom.

8: Two-part oil wiping ring (10) according to claim 1, wherein the ring body (7) consists of steel or cast iron.
